(19) United States
(12) Patent Application Publication
(10) Pub. No.: US 2006/0221847 A1
(43) Pub. Date: Oct. 5, 2006

(54) Method and apparatus for selecting transmission modulation rates in wireless devices for A/V streaming applications

(76) Inventor: Behram Mario Dacosta, San Diego, CA (US)

Correspondence Address: O'BANION & RITCHEY LLP/ SONY ELECTRONICS, INC., 400 CAPITOL MALL, SUITE 1550, SACRAMENTO, CA, 95814, US

(21) Appl. No.: 11/094,386

(22) Filed: Mar. 29, 2005

(51) Int. Cl. H04Q 1/20

(52) U.S. Cl. 370/252; 375/338

(57) ABSTRACT

A-priori performance measures of a wireless communication system, combined with channel signal to noise ratio and/or signal to interference and noise ratio (SNR/SINR) measurements, are used to determine transmission modulation rate to help optimize real-time streaming. The method and apparatus minimize packet error rates (PER) without actually measuring packet error rates. Instead the receiver measures SNR/SINR and the transmitter uses this measured SNR/SINR data along with information about PER vs. Modulation vs. SNR/SINR to adjust the transmission rate.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to wireless communications, and more particularly to streaming applications of wireless devices, and most particularly to selecting modulation rates in wireless systems to optimize real-time or A/V streaming.

2. Description of Related Art

Wireless communications have proliferated in recent years. The basic feature of wireless communication is transmitting and receiving information-carrying modulated RF carrier signals through the air, without wires, between senders and receivers. Various modulation techniques are used. These modulation techniques vary in robustness. Generally a more robust technique has a lower transfer rate but produces fewer errors, while a less robust technique transmits at a higher rate but produces more errors.

One particular type of wireless communication system is the wireless local area network (WLAN). WLANs are built according to a number of standards, particularly several 802.11x IEEE standards. Information is typically sent as packets, containing identifying information, the actual information, and error information. The complete message may be contained in a number of different packets.

In an 802.11x WLAN (and many types of wireless systems) it is usually necessary to determine the maximum data rate as which a transmission can occur from a transmitter to a receiver. Selecting the maximum data rate is necessary to maximize utilization of resources, and to service as many clients as possible. In 802.11x WLANs, the transmission data rate is typically selected adaptively based on packet error rates (PERs).

The adaptive prior art method is illustrated in the flowchart of FIG. 1. Transmission of data packets is initiated at some, typically the maximum, data rate. Transmission proceeds at the selected rate (initially the maximum rate). The transmitted packets are received and the PER is measured. Based on the PER, the transmission rate is adjusted and transmission continues at the new rate. The process continues and the rate is adjusted (up or down) as more packets are transmitted and received.

For example, initially the maximum data rate (corresponding to the most complex modulation) may be 54 Mbps, corresponding to a modulation of 64 QAM. If more than three transmission errors occur sequentially at this data rate, the data rate may be decreased to 48 Mbps, and if three transmission errors occur sequentially at 48 Mpbs, the transmission data rate is decreased to 36 Mbps (16 QAM), which is a more robust but less efficient modulation scheme. If more than ten successful packets are transmitted at 36 Mbps, then the data rate may be increased to 48 Mbps.

The above scheme works well for data centric applications such as web browsing, or email synchronization. The adaptive rate selection mechanism is aggressive in maximizing the data rate, but it does so by causing packet transmission errors, and it uses these transmission errors to estimate the limits of performance. If parameters are carefully selected these transmission errors are reduced, and combined with 802.11x retransmissions, data transfers are acceptably reliable and fast.

A problem occurs for high throughput and real-time applications where packet errors can cause packets to be received too late to be useful, or where packet error rates (and the following delays caused by retransmissions) cause the transmit data buffers to overflow. In addition, the aggressive scheme mentioned above results in frequent fluctuations to the transmit data rate, which can affect the viewed video quality in A/V streaming applications, for example in cases where the transmitted video is transrated to match the available 802.11x bandwidth. In such applications, it is desirable to minimize the number of packet transmission errors. A simple solution would be to simply transmit at the lowest data rate (simplest modulation), e.g. 6 Mbps for 802.11a. However this is usually unacceptable since it greatly underutilizes the wireless medium. Hence the goal of an algorithm used to select the transmission rate for real-time or A/V streaming applications on wireless links should be to select a modulation that maximizes the transmission data rate while simultaneously avoiding any packet errors, and decreasing data rate fluctuations.

### BRIEF SUMMARY OF THE INVENTION

An aspect of the invention is a method and apparatus for determining the transmission rate in a wireless communication system, by initiating transmission at an initial data rate; transmitting data packets at a selected rate which is initially the initial rate; receiving transmitted data packets; measuring at least one of the signal to noise ratio (SNR) or signal to interference and noise ratio (SINR) to produce a measured SNR/SINR signal; and adjusting the transmission rate based on the measured SNR/SINR signal and information about packet error rate (PER) as a function of SNR/SINR.

The invention applies particularly to data streaming applications, and can be implemented with wireless local area networks (WLANs). The invention adjusts the transmission rate to a maximum while avoiding packet errors without measuring PER. A headroom can be subtracted from the measured SNR/SINR value and the modified value used to determine transmission rate. An average SNR/SINR value can also be used.

Another aspect of the invention is a wireless communication system apparatus, including a transmitter for transmitting data packets at a selected rate, and having a transmission rate control section which adjusts the transmission rate based on measured SNR/SINR and information about packet error rate (PER) as a function of SNR/SINR; and a receiver for receiving the transmitted data packets, and having a SNR/SINR detection section for detecting at least one of signal to noise ratio (SNR) and signal to interference and noise ratio (SINR) of the received data packets to produce the measured SNR/SINR signal.

A still further aspect of the invention is a wireless communication system apparatus, including means for transmitting data packets at a selected rate; means for receiving transmitted data packets; means for measuring at least one of the signal to noise ratio (SNR) or signal to interference and noise ratio (SINR) of the received data packets to produce a measured SNR/SINR signal; and means for adjusting the transmission rate based on the measured SNR/SINR signal and information about packet error rate (PER) as a function of SNR/SINR.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a flowchart of the prior art adaptive rate selection method.

FIG. 2 is a flowchart of the rate selection method of the present invention.

FIG. 3 is a schematic diagram of a wireless communication apparatus that implements the present invention.

FIG. 4 is a flowchart of the additional feature of the invention of using a headroom in the rate determination.

FIG. 5 is a schematic diagram of the additional feature of the invention of using a headroom in the rate determination.

FIG. 6 is a flowchart of the additional feature of the invention of using an average SINR value in the rate determination.

FIG. 7 is a schematic diagram of the additional feature of the invention of using an average SINR value in the rate determination.

FIG. 8 is a flowchart of another embodiment of a rate selection method according to the invention.

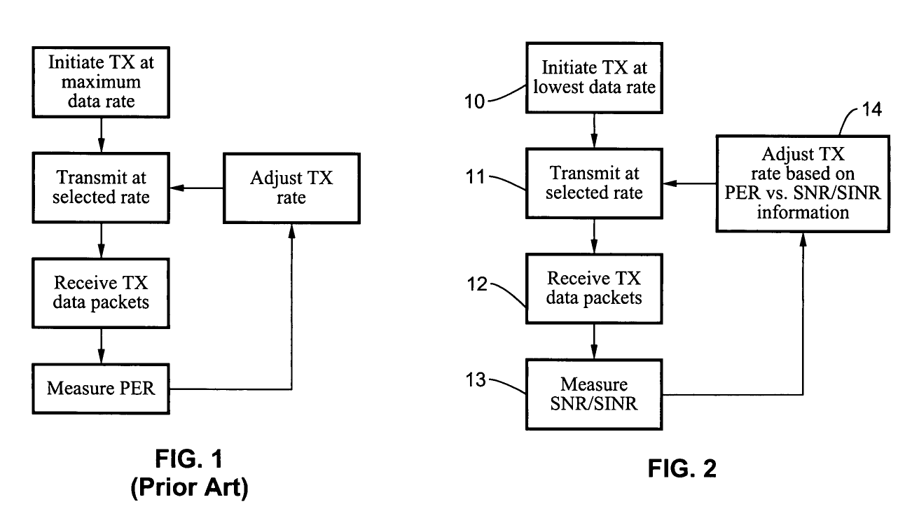

### DETAILED DESCRIPTION OF THE INVENTION

Referring more specifically to the drawings, for illustrative purposes the present invention is embodied in the method and apparatus generally shown in FIG. 2 through FIG. 8. It will be appreciated that the apparatus may vary as to configuration and as to details of the parts, and that the method may vary as to the specific steps and sequence, without departing from the basic concepts as disclosed herein.

The rate selection method of the invention is illustrated in the flowchart of FIG. 2. Transmission of data packets is initiated at some, typically the lowest, data rate, as shown at step 10. Transmission proceeds at the selected rate (initially the lowest rate), step 11. The transmitted packets are received, step 12, and the SNR/SINR (signal to noise ratio or signal to interference and noise ratio or both) is measured, step 13. Based on the measured SNR/SINR and information about PER (packet error rate) as a function of SNR/SINR (as will be further explained below), the transmission rate is adjusted, step 14, and transmission continues at the new rate, step 11. The process continues and the rate is adjusted (up or down) as more packets are transmitted and received.

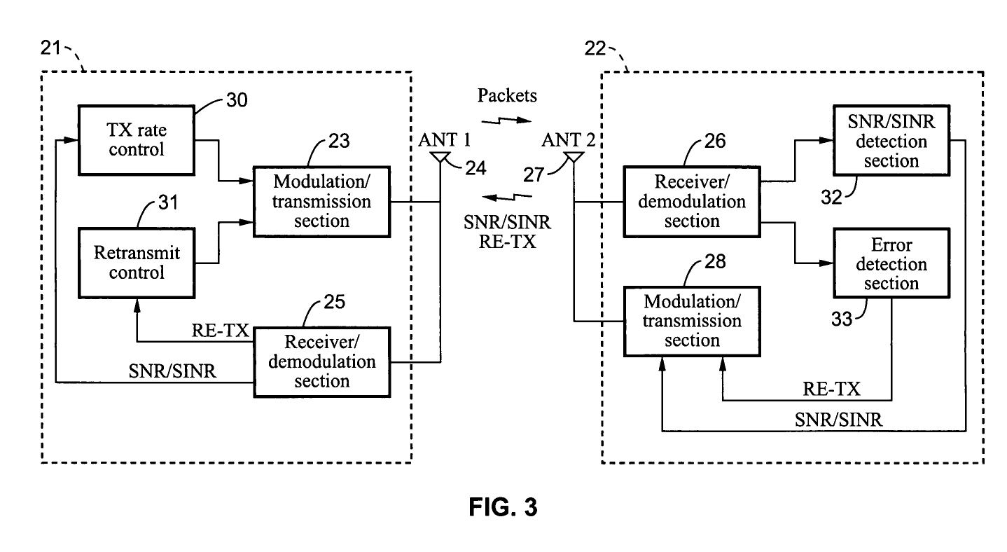

FIG. 3 shows a wireless communication apparatus 20, including a transmitter (TX) 21 and a receiver (RX) 22. Transmitter 21 can also receive data and receiver 22 can also transmit data, so they are both in a more general sense “transceivers”, but in the illustrative wireless system 20, the primary function of TX 21 is to send data to RX 22, and the primary function of RX 22 is to receive data from TX 21, e.g. TX 21 is a base station and RX 22 is a remote station. Transmitter 21 contains a modulation and transmission (mod/TX) section 23 connected to an antenna (ANT1) 24, and also a receiver and demodulation (RX/demod) section 25, also connected to antenna 24. Receiver 22 contains a receiver and demodulation section 26 connected to an antenna (ANT2) 27, and also a modulation and transmit section 28, also connected to antenna 27. These sections are basic components of a wireless system, and are well known in the art, and can be implemented in many different embodiments and configurations, so they are shown in general functional representations. The invention does not depend on a particular physical implementation, configuration or embodiment thereof.

TX 21 also contains a TX Rate Control section 30 and a Retransmit Control section 31, both connected to modulation/transmission section 23. TX Rate Control section 30 controls the rate at which data is transmitted by mod/TX section 23. Retransmit Control section 31 controls the retransmission by TX 21 of packets that were received at RX 22 with errors. RX 22 also contains SNR/SINR Detection section 32 and Error Detection section 33, both connected to receiver/demodulator section 26. SNR/SINR Detection section 32 measures the signal to noise ratio (SNR) or alternatively the Received Signal Strength Index (RSSI), and preferably also the signal to interference and noise ratio (SINR), of the signals received at the RX 22. Any one or more of these three parameters (SNR, RSSI, SINR) may be measured and used in carrying out the invention, though ideally all three values are used. The measured value will generally be referred to as SNR/SINR. Error Detection section 33 measures the errors in packets received at RX 22, and may also measure the packet error rate (PER). Error detection is necessary so that erroneous or lost packets may be retransmitted.

In operation, in wireless system 20, TX 21 transmits data packets from ANT1 to ANT2 at RX 22. If errors are detected in the received packets, Error Detection section 33 will typically discard the packet, and in addition an ACK (acknowledge) packet will not be sent back to TX21 for this received packet (or for a group of received packets that include this packet, as is done in some communication protocols). The absence of an ACK packet will cause a retransmission from TX21. The process of generating a retransmission of packets is represented by a retransmit (RE-TX) signal in FIG. 3.

Also in operation of wireless system 20, in accordance with the invention, SNR/SINR Detection section 32 measures the SNR and/or SINR of the received data packets and sends a SNR/SINR signal through mod/TX section 28 back to RX/demod section 25 which inputs the signal into TX Rate Control section 30. TX Rate Control section 30 uses the SNR/SINR data in combination with information about the PER as a function of SNR/SINR (as will be discussed further below) to determine the best transmission rate, and thereby controls the rate of modulation/transmission of the data packets.

Information can be transmitted over a wireless channel by any of a variety of transmission modes, i.e. particular modulation types and rates. The present invention does not require any particular transmission mode. The invention applies to wireless systems operating with any transmission mode suitable for the application. Thus, wireless system 20 may operate with the various levels of QAM (Quadrature Amplitude Modulation), including 4 QAM, 16 QAM, 64 QAM and 256 QAM (also known as X-level QAM or QAM-X), but also with other modes, including BPSK, QPSK, PSK, GMSK, and FSK.

The invention applies to 802.11x wireless local area networks (WLANs) and to many other types of wireless systems. It is directed to determining the maximum data rate at which a transmission can occur from a transmitter to a receiver. Selecting the maximum data rate is necessary to maximize utilization of resources, and to service as many clients as possible.

The invention applies particularly to high throughput and real-time applications where packet errors can cause packets to be received too late to be useful, or where packet error rates (and the following delays caused by retransmissions) cause the transmit data buffers to overflow. One particular application of the present invention is A/V (audio-video or audio-visual) streaming applications, for example in cases where the transmitted video is transrated to match the available 802.11x bandwidth. In such applications, it is desirable to minimize the number of packet transmission errors, but simply transmitting at the lowest data rate (simplest modulation), e.g. 6 Mbps for 802.11a, is usually unacceptable since it greatly underutilizes the wireless medium. Also the prior art technique results in frequent fluctuations to the transmit data rate, which can cause buffer overflows and also affect the viewed video quality. Hence the invention provides an algorithm used to select the transmission rate for real-time or A/V streaming applications on wireless links that selects a modulation that maximizes the transmission data rate while simultaneously decreasing packet error rates, and decreasing data rate fluctuations.

The invention minimizes packet errors without explicitly measuring packet error rates. It does so by using a-priori information about performance of the wireless hardware, and works as follows. (The examples will be for 802.11x, but apply equally to other wireless technologies).

Transmissions to a new remote device may start at the lowest modulation/data rates supported. There are two versions or embodiments of the invention. In the basic version, the transmitter measures the SINR and other data for previous packets such as ACK packets it has previously received from the receiver, and uses these as an estimate for what the receiver would have measured for packets it receives. The second version of the invention (usually more ideal) is where the receiver measures the SINR etc and sends these back to the transmitter. In the first version of the invention, the transmitter measures the SNR (signal to noise ratio) or RSSI (Received Signal Strength Index), and ideally SINR (signal to interference and noise ratio), of the packets it receives from the remote device Based on the transmitter's knowledge (or estimate) of PER (packet error rate) of different modulations at different SNRs/SINRs at the receiver, the transmitter can estimate the modulation to provide a suitably low PER. Receive sensitivity data describing SNR at different modulations that provide particular levels, e.g. 10%, PER is standard performance data provided by WLAN chipset vendors. The final data used for these calculations should take into account the overall system of which the WLAN chipsets are a part, for example antenna gains.

The above procedure allows selecting a modulation that provides a suitably low PER at a give instant in time, given the measured SNR/SINR between the wireless transmitter and wireless receiver. It does not however do anything to decrease the fluctuation of modulation (and hence data rates and throughput) over time. Movement of objects in the environment (among other causes) can cause the SNR and SINR to change over time. While such changes should automatically be taken into account by the changes in SNR/SINR determined at the transmitter and the changes in modulation of the transmitted data, the transmitter may be unable to sample the RF channel frequently enough, causing the SNR/SINR to decrease to levels that cause transmission errors before the channel has been resampled. Sampling of the RF channel occurs during reception of packets. In the first version of the invention, every time the TX receives an ACK packet from the receiver, during reception of the ACK packet the TX can estimate SINR etc.; hence this can occur within 100 μs, or it can occur after a period of several msec or even seconds. In the second version of the invention (described below), the receiver samples the RF channel every time it receives a packet from the TX, and the receiver then sends a summary of SINR etc. it has measured back to the TX. The transmission of this summary information can occur whenever necessary but in order to not overburden the link capacity will typically occur not more frequently than about 1 msec at today's modulation rates.

Hence it is desirable to build some headroom or safety margin into the estimated modulation. Such a headroom factor is also useful to account for inaccuracies in the data/specifications/performance of the wireless chipsets, and inaccuracies in measurements, for example due to varying multipath delay distributions. This headroom is implemented by subtracting a value, e.g. k, from the measured SNR/SINR, prior to finding the appropriate modulation to yield a given PER at that SNR/SINR. The magnitude of k may be considered to be a temporal fade margin, and hence can be determined by considering curves describing the PDFs (probability distribution functions) of fade magnitudes in the environment and the rate of change of the RF channel in the environment. Hence k may be determined either by a-priori estimates of the user's RF environment, or from actual measurements by the wireless system during operation in the user's environment.

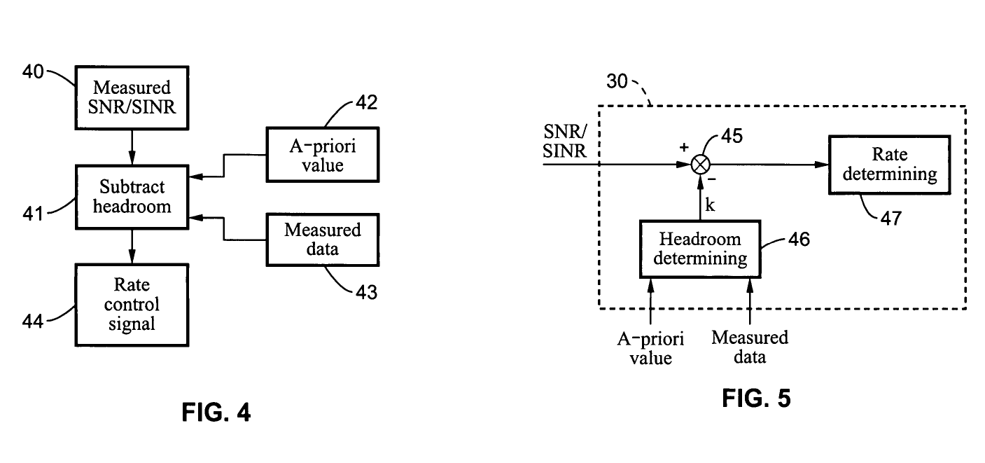

This additional feature of the invention, i.e. applying a headroom to the rate determination, is illustrated in FIG. 4 and FIG. 5. FIG. 4 is a flowchart of the method of using a headroom in the determination of a rate control signal. The measured SNR/SINR signal is obtained, step 40, as discussed above. The headroom is subtracted from the SNR/SINR value, step 41. The headroom is determined by either inputting an a-priori value, step 42, or from measured data, step 43. The resulting SNR/SINR with margin (SNR/SINR—k) is used to determine the rate, step 44.

FIG. 5 shows the apparatus corresponding to the method of FIG. 4. The SNR/SINR signal (from RX/demod 25) is input into a summation (subtraction) unit 45 in TX Rate Control section 30. Headroom Determining unit 46 inputs the headroom value k into summation (subtraction) unit 45 where it is subtracted from SNR/SINR. Headroom Determining unit 46 determines the headroom either from an a-priori value or from measured data, shown as two inputs to unit 46. The adjusted SNR/SINR value from summation unit 45 is input into Rate Determining unit 47 where the rate control signal is generated.

In addition, in order to prevent changes being made too frequently to the transmission data rate, the algorithm is modified accordingly. For example, a running average of the past N SINR values can be maintained, and this average can be used to determine the transmission data rate. However, the running average may be disregarded, and the actual value of SINR used, in the case where the present value of SINR decreases by more than M s.d. (standard deviation) units from the running average.

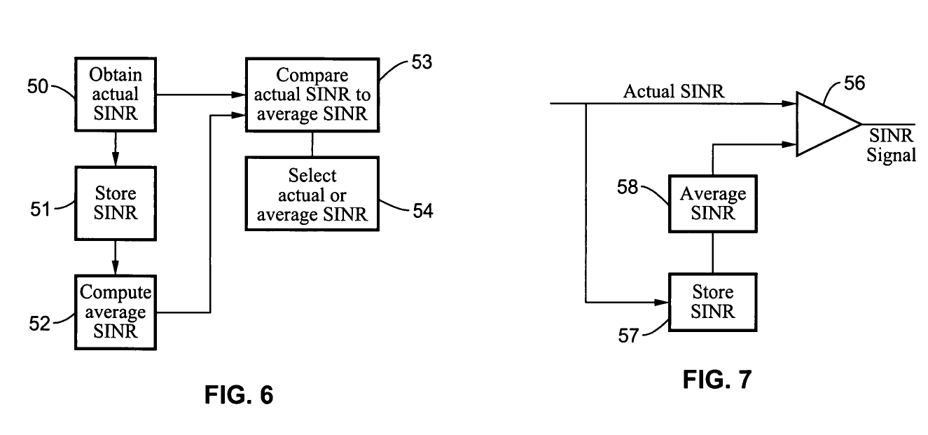

This additional feature of the invention, i.e. using SINR average values in the rate determination, is illustrated in FIG. 6 and FIG. 7. FIG. 6 is a flowchart of the method of using average values of SINR in the determination of a rate control signal. Actual (i.e. current) SINR values are obtained, step 50. As the SINR values are obtained, they are stored, step 51, and an average value is obtained, step 52. The current actual value is compared to the average value, step 53. The value of SINR to be used in the rate determination is selected from the current and average values, step 54. The average value will generally be selected, to reduce fluctuations in the data rate, unless a condition is met for selecting the present value, e.g. a significantly large change from the average value.

FIG. 7 shows the apparatus corresponding to the method of FIG. 6. The actual (i.e. current) SINR in input into a comparator 56 and is also input into a storage device 57 where past values are stored. The stored values are averaged in averaging device 58, and the average value is also input into the comparator 56. The comparator output is the value of SINR to be used in the rate determination. The average value will generally be selected, to reduce fluctuations in the data rate, unless a condition is met for selecting the present value, e.g. a significantly large change from the average value. The apparatus of FIG. 7 may be placed at the output of SNR/SINR Detection section 32 or at the input of TX Rate Control section 30 of FIG. 3.

### EXAMPLE

Current SNR/SINR: −74 dBm

Average SNR over past 10 samples: −70 dBm

Margin (headroom): 14 dBm

Actual “SNR/SINR with margin” to use: −70−14=−84 dBm

Receive sensitivity at −80 dBm: 18 Mbps at 5% PER

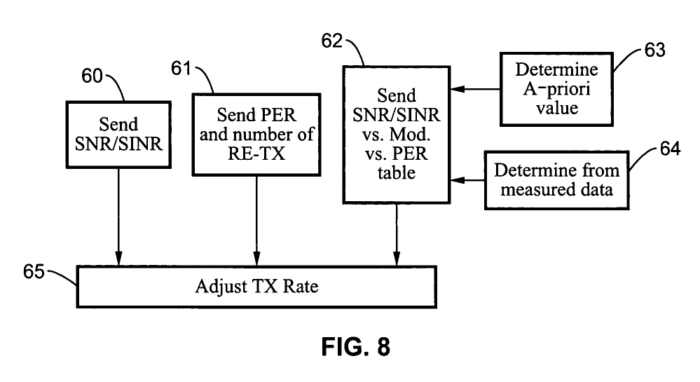

Ideally the following is done in a further embodiment of the invention, shown in FIG. 8, as an improvement to the rate determination based on measurement of SNR/SINR/RSSI described above. This is the second version of the invention, where the estimates are sent back from the RX to the TX. The remote device sends back to the transmitter received SNR/SINR of the most recent packet received from transmitter, step 60. Also periodically sent is the most recent PER and number of retransmissions since the last such report, step 61. Also sent, step 62, is a table containing PER at different modulations for a particular SINR for the hardware used at the receiver, i.e. an a-priori table of receive sensitivities of the receiver hardware, provided in step 63. The table need not be sent with every packet, but may be sent only once per session, or once during initial association between the two devices. The SNR/SINR information is ideally contained in packets normally sent to the transmitter, and hence do not contribute to additional packets. The TX rate is adjusted based on all this information, step 65.

As described, the a-priori curves of SNR/SINR vs. Modulation vs. PER from step 63 can be used. It is also possible, step 64, to continuously obtain this data from the actual data transmissions underway, and to construct these curves during the actual transmissions, instead of using a-priori information. Steps 63 or 64 can be used to provide the PER vs. SNR/SINR information used in other embodiments of the invention.

Also note that there is a pathological condition in which the link strength (as measured by SNR/SINR) may suddenly decrease in quality by a huge extent. In this case the SNR/SINR would not be updated to this new lower value since no new packets have been detected as being received at all. In such pathological cases decreasing the modulation rate will usually not help anyway, but the invention does avoid this condition by simultaneously monitoring packet retransmission rates (provided in step 61). Packet retransmission rates at the TX and RX are used to (a) detect when the SNR/SINR based method is not accurate, in which case alternative action may be taken (e.g. the margin may be made more conservative), or (b) when the link has completely failed.

It should be apparent that the logic of the algorithm described herein can be implemented in other variations. In addition, the entire method may be implemented in similar variations.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A method for determining the transmission rate in a wireless communication system, comprising:
initiating transmission at an initial data rate;
transmitting data packets at a selected rate which is initially the initial rate;
receiving transmitted data packets;
measuring at least one of the signal to noise ratio (SNR) or received signal strength index (RSSI) or signal to interference and noise ratio (SINR) to produce a measured SNR/SINR signal; and
adjusting the transmission rate based on the measured SNR/SINR signal and information about packet error rate (PER) as a function of SNR/SINR.

2. A method as recited in claim 1, wherein the data packets are transmitted and received in a wireless communication system that is performing a real-time streaming application.

3. A method as recited in claim 1, wherein the data packets are transmitted and received in a wireless communication system that is formed of a wireless local area network (WLAN).

4. A method as recited in claim 1, wherein the initial data rate is the lowest data rate and the rate is adjusted to the maximum rate that provides a predetermined PER level.

5. A method as recited in claim 1, further comprising determining PER vs. SNR/SINR information from a-priori values.

6. A method as recited in claim 1, further comprising determining PER vs. SNR/SINR information from measured data from the actual transmissions.

7. A method as recited in claim 1, further comprising subtracting a headroom value from the measured SNR/SINR value and using this modified SNR/SINR as the basis for adjusting the transmission rate.

8. A method as recited in claim 7, further comprising determining the headroom from either an a-priori value or measured data.

9. A method as recited in claim 1, further comprising:
computing an average SNR/SINR value over a plurality of transmitted data packets; and
using the average value as the basis for adjusting the transmission rate.

10. A method as recited in claim 1, further comprising periodically providing recent PER data and the number of data packet retransmissions as a further basis for adjusting the transmission rate.

11. A wireless communication system apparatus, comprising:
a transmitter for transmitting data packets at a selected rate, including:
a transmission rate control section which adjusts the transmission rate based on a measured SNR/SINR signal and information about packet error rate (PER) as a function of SNR/SINR; and
a receiver for receiving the transmitted data packets, including:
a SNR/SINR detection section for detecting at least one of signal to noise ratio (SNR) and signal to interference and noise ratio (SINR) of the received data packets to produce the measured SNR/SINR signal.

12. An apparatus as recited in claim 11, wherein the wireless communication system comprises a real-time streaming system.

13. An apparatus as recited in claim 11, wherein the wireless communication system comprises a wireless local area network (WLAN).

14. An apparatus as recited in claim 11, wherein the transmission rate control section further comprises a summation element for subtracting a headroom value from the measured SNR/SINR value to produce a modified SNR/SINR which is used as the basis for adjusting the transmission rate.

15. An apparatus as recited in claim 11, further comprising:
a storage device for storing measured SNR/SINR values over a plurality of transmitted data packets;
an averaging device for computing an average SNR/SINR value over a plurality of transmitted data packets; and
a comparator for comparing the current measured SNR/SINR to the average SNR/SINR and selecting either the current value or the average value as the basis for adjusting the transmission rate.

16. An apparatus as recited in claim 15, wherein the comparator is set to select the average value unless the current value differs from the average value by more than a preselected value.

17. An apparatus as recited in claim 15, wherein the storage device, averaging device, and comparator are located either in the receiver at the output of the SNR/SINR detection section or in the transmitter at the input to the transmission rate control section.

18. An apparatus as recited in claim 11:
wherein the transmitter further comprises:
a first modulation and transmission section;
a first antenna connected to the first modulation and transmission section;
a first receiver and demodulation section connected to the first antenna;
the transmission rate control section being connected to the first receiver and demodulation section and to the first modulation and transmission section; and
wherein the receiver further comprises:
a second receiver and demodulation section;
a second antenna connected to the second receiver and demodulation section;
a second modulation and transmission section connected to the second antenna;
the SNR/SINR detection section being connected to the second receiver and demodulation section and to the second modulation and transmission section;
wherein the measured SNR/SINR signal from the SNR/SINR detection section is transmitted by the second modulation and transmission section, from the second antenna to the first antenna, and through the first receiver and demodulation section to the transmission rate control section.

19. An apparatus as recited in claim 18:
wherein the receiver further comprises an error detection section connected to the second receiver and demodulation section and to the second modulation and transmission section; and
wherein the transmitter further comprises a retransmit control section connected to the first receiver and demodulation section and to the first modulation and transmission section;
wherein the error detection section detects errors in received data packets and produces a retransmit signal which is transmitted to the retransmit control section which causes the transmitter to retransmit erroneous or lost data packets.

20. A wireless communication system apparatus, comprising:
means for transmitting data packets at a selected rate;
means for receiving transmitted data packets;
means for measuring at least one of the signal to noise ratio (SNR) or signal to interference and noise ratio (SINR) of the received data packets to produce a measured SNR/SINR signal; and
means for adjusting the transmission rate based on the measured SNR/SINR signal and information about packet error rate (PER) as a function of SNR/SINR.
